(19) United States
(12) Patent Application Publication
(10) Pub. No.: US 2011/0123700 A1
(43) Pub. Date: May 26, 2011

(54) INSTANT LIQUID TEA CONCENTRATE

(76) Inventor: Pasan Thijee PETHTHAWADU, Ambalangoda (LK)

(21) Appl. No.: 12/625,782

(22) Filed: Nov. 25, 2009

(51) Int. Cl. A23F 3/40; A23F 3/12; A23F 3/28; A23F 3/30

(52) U.S. Cl. 426/597; 426/428; 426/400

(57) ABSTRACT

The patent is a new development of an Instant Liquid Tea Concentrate, according to the norms and standards of food science and related industries. Since the discovery of tea as a healthy drink some 4000 years ago, conventionally, the tea leaves have been dissolved in hot or cold water before consumption. The derivatives of tea would dissolve in hot or cold water with flavor and aromas creating a tasty, healthy drink. A tea bag, for instance, uses the same traditional method, though with reduced preparatory hazard.

In addition, tea extracts in powder forms are manufactured with chemical extraction methods. In a number of processes, the tea extract in powder form is followed by the preparation of aqueous tea concentrates as a secondary product.

Accordingly, the powdered tea extracts is dispersed in water while adding preservatives in order to manufacture aqueous tea concentrates. This aqueous tea concentrates differ from the “INSTANT LIQUID TEA CONCENTRATE”. In fact, aqueous tea concentrates are secondary products but, they are not direct end products of the particular extraction method but the INSTANT LIQUID TEA CONCENTRATE is a direct result of the respective process.

The new development makes it possible for the derivatives that create both the flavour and the aroma (and even other dormant aroma) to be extracted to a liquid base, the final product being—Liquid Tea Concentrate in instant form. Accordingly, the base used for the Instant Liquid Tea Concentrate manufacture is glycerol (or its equivalent forms of 1,2,3 Propanetriol or Glycyl alcohol or Glycerin—in lieu of Glycerol). The final product—Instant Liquid Tea Concentrate can be added to hot or cold water instead of tea leaves or aqueous tea concentrates at the final point of consumption.

Tea refers to the botanical name “Camellia sinensis” which comprises of four main types—black tea, green tea, white tea or oolong tea can be used for the development, making it possible for the consumers to prepare an instant tea using the Instant Liquid Tea Concentrate. The most commonly found tea on the market are black tea, oolong tea, green tea and white tea, all of which can be made from the same tea bushes.

Drinking of tea has become a general custom, habit and even a ritual for world population. Traditionally and conventionally, tea leaves are macerated in hot water for about 2-3 minutes, as its aromatic substances, antioxidants, proteins and starches dissolve in hot or cold water. Finally, a drinkable cup of tea is prepared. Thus, the method of preparing a cup of tea is a universal practice and a general norm in the world.

In other form of method, a cup of tea is also prepared with aqueous tea concentrates.

The aqueous tea concentrates are manufactured with a base product namely the powdered tea extracts. Accordingly, the powdered tea extracts are dispersed in water in complying with pre-determined concentration value adding preservatives to the solution in which, as a result, aqueous tea concentrates are manufactured.

The base product for aqueous tea concentrates—tea extract, which is in powder form, is a derivative of a chemical extraction process. In this particular chemical extraction process, tea leaves are subjected to mix with an alkali—Potassium hydroxide which helps tea compounds take out into the alkali solution. As the alkali solution reaches its saturated level with the tea compounds, the bulky mixture is passed through a centrifugal separator recovering an alkalized aqueous tea solution. Subsequently, recovered alkalized aqueous tea solution is neutralized with a weak acid. However, during the neutralization, de-ionization takes place removing residual salts that forms in the neutralization of alkalized aqueous tea solution.

Finally, neutralized aqueous tea solution is spray dried gaining tea extract in powder form, which is used as a base product for preparing aqueous tea concentrates.

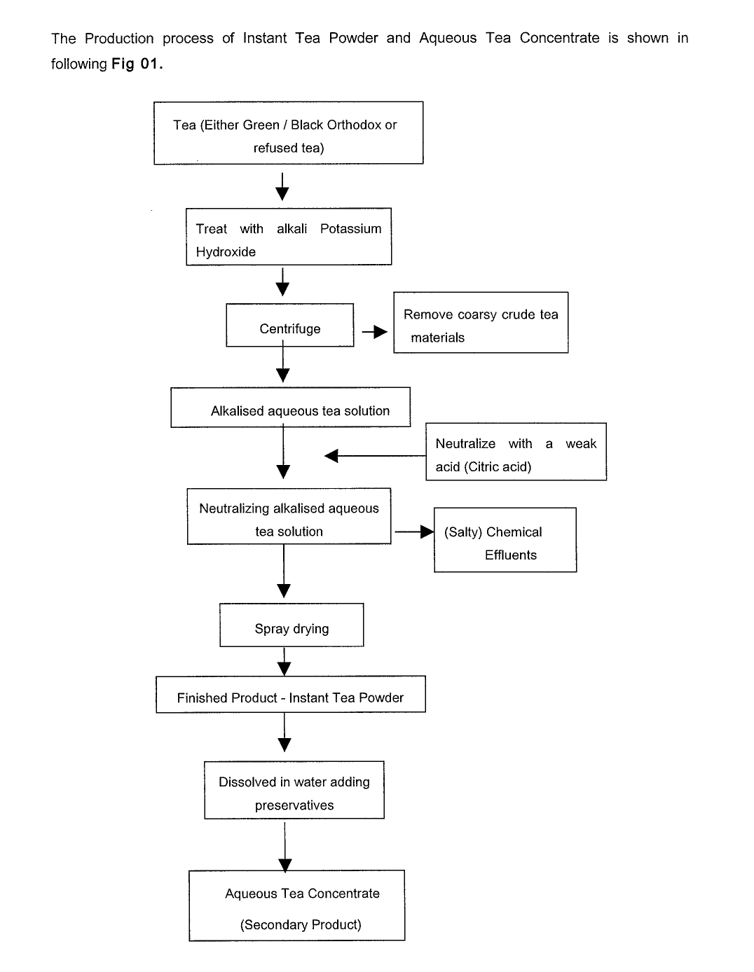

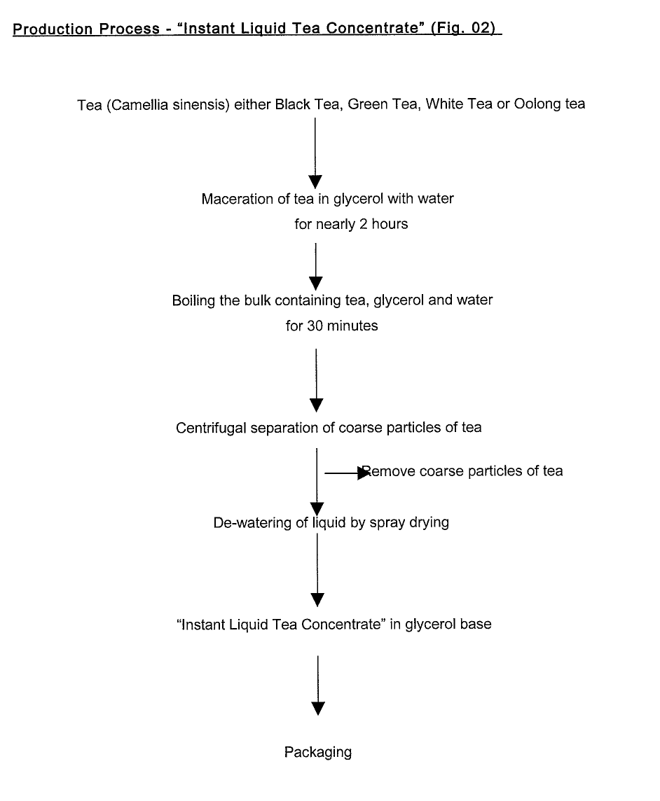

(Production process is illustrated in following pages—FIG. 01)

Consequently, aqueous tea concentrates serve preparation of tea cups instantly.

However, following is a description of the process involved in manufacturing “Instant Liquid Tea Concentrate” in glycerol base (or its equivalents). Materials for the production of Instant Liquid Tea Concentrate in glycerol base (or equivalents) are
1. Tea, which belongs to “Camellia sinensis” comprising of four main types—black tea, green tea, white tea or oolong Tea
2. Glycerol or its equivalent forms of 1, 2, 3 Propanetriol or Glycyl alcohol or Glycerin—(in lieu of glycerol)
3. Water.

Firstly, tea (Camellia sinensis) either black tea, green tea, white tea or oolong Tea in 40% dry solid content are set to macerate in closed sterilized tanks for nearly 2 hours with 65% and 35% glycerol, water contents respectively.

For example—

When 400 g of tea (Camellia sinensis) either black tea, green tea, white tea or oolong Tea is used—(40% in dry solid)
650 g of glycerol is added—(65% glycerol of the net weight of liquid)
350 g of water is added—(35% water of the net weight of liquid)

Then, the bulk containing water, glycerol and tea (Camellia sinensis) black tea, green tea, white tea or oolong tea is boiled for 30 minutes. After, the bulk is boiled, coarse particles of tea are removed through centrifugal separation thus obtaining a clarified liquid. Subsequently, the bulk is de-watered by a spray drying method. The final product “Instant Liquid Tea Concentrate” in glycerol base in liquid form is collected to closed sterilized chambers for filling to containers. (Production process is illustrated in the following pages—FIGS. 02 & 04)

The appearance and texture of “Instant Liquid Tea Concentrate” in glycerol base is clear, clarified liquid. In addition, the colours of particular concentrated tea liquids take their respective base colours—in particular, black tea, green tea, white tea and oolong tea get dark reddish, amber-green, light amber & greenish brown colours respectively, in particular concentrates.

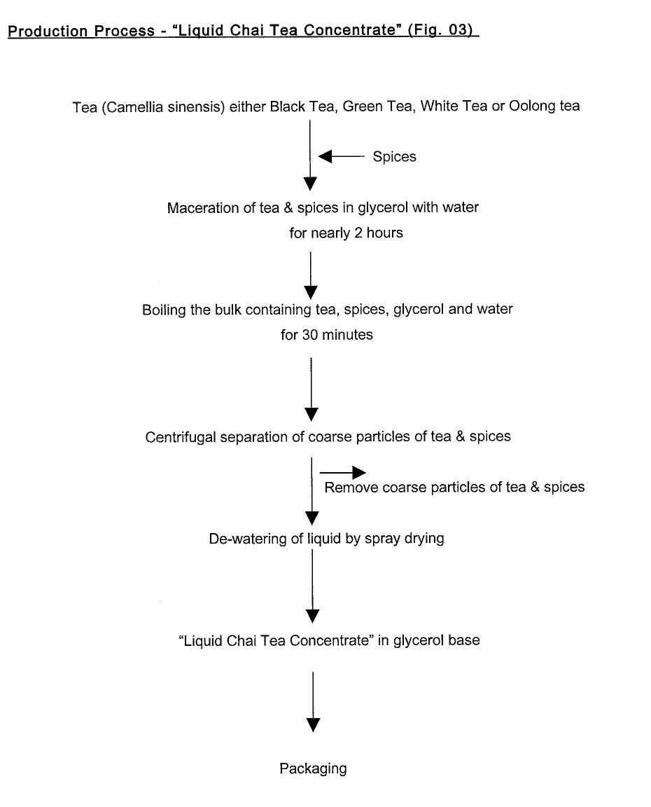

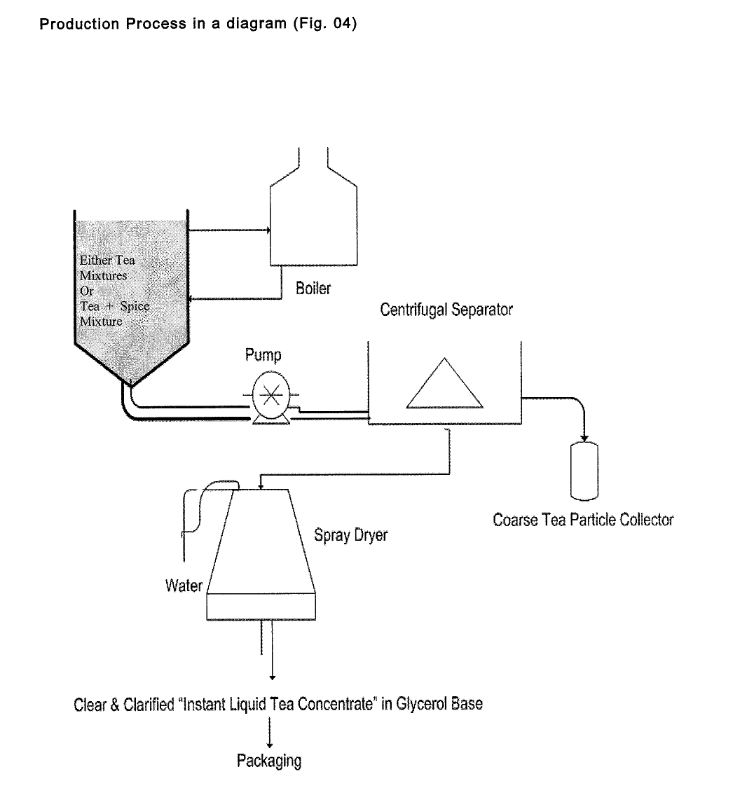

In addition, the same process techniques are practiced to manufacture Liquid Chai Tea Concentrate, which is an instant form of a blend of tea (Camellia sinensis) and spices.—(FIGS. 03 & 04)

Accordingly, a blend of tea (Camellia sinensis) comprising of either black tea, green tea, white tea or oolong tea and spices in 40% dry solid content are set to macerate in closed sterilized tanks for nearly 2 hours with 65% and 35% glycerol, water contents respectively.

For example—

When 400 g of a blend of tea (Camellia sinensis) either in the form of black tea, green tea, white tea or oolong Tea and spices are used—(in 40% dry solid)
650 g of glycerol is added—(65% glycerol of the net weight of liquid)
350 g of water is added—(35% water of the net weight of liquid)

Then, the bulk containing water, glycerol and a blend of tea (Camellia sinensis) either in the form of black tea, green tea, white tea or oolong Tea and spices is boiled for 30 minutes. After, the bulk is boiled, coarse particles of the tea and spices are removed through centrifugal separation thus obtaining a clarified liquid. Subsequently, the bulk is de-watered by a spray drying method. The final product Liquid Chai Tea Concentrate, an instant form of a blend of tea (camellia sinensis) either in the form of black tea, green tea, white tea or oolong Tea and spices, in glycerol base is collected to closed sterilized chambers for filling to containers.

Chemically, glycerol is a tri-hydric alcohol (1,2,3 Propanetriol or Glycyl alcohol) and in food manufacturing, it is used as a solvent, emulsifier and a sweetening agent. Glycerin is a synonym for glycerol. Therefore, both glycerol and glycerin are chemically a tri-hydric alcohol and called 1,2,3 Propanetriol or Glycyl alcohol.

This innovative product is manufactured in closed sterilized tanks with utmost quality standards and quality control measures using sophisticated technological apparatus and devices.

1. A liquid tea concentrate, comprising:
a tea component;
water; and
a base liquid.

2. The liquid tea concentrate of claim 1, wherein the tea component comprises at least one of black tea, green tea, white tea, and oolong tea.

3. The liquid tea concentrate of claim 2, further comprising spices.

4. The liquid tea concentrate of claim 1, wherein the base liquid is Glycerin.

5. The liquid tea concentrate of claim 4, wherein the Glycerin is at least one of glycerol, 1,2,3 propanetriol and glycyl alcohol.

6. A method for manufacturing a liquid tea concentrate, the method comprising:
combining tea, glycerin and water to form a tea mixture;
macerating the tea mixture in a closed tank to form a tea bulk;
boiling the tea bulk to form a boiled tea bulk;
removing coarse particles from the boiled tea bulk to form a clarified liquid;
spray drying the clarified liquid to form a liquid tea concentrate.

7. The method for manufacturing a liquid tea concentrate of claim 6, wherein the tea comprises at least one of black tea, green tea, white tea, and oolong tea.

8. The method for manufacturing a liquid tea concentrate of claim 7, further comprising the step of adding spices to the tea mixture.

9. The method for manufacturing a liquid tea concentrate of claim 6, wherein the tea is provided as a 40% dry solid.

10. The method for manufacturing a liquid tea concentrate of claim 6, wherein the glycerin comprises at least one of glycerol, 1 2,3 propanetriol and glycyl alcohol.

11. The method for manufacturing a liquid tea concentrate of claim 6, wherein the glycerin is provided as 65% of the net liquid weight of the tea mixture and the water is provided as 35% of the net liquid weight of the tea mixture.

12. The method for manufacturing a liquid tea concentrate of claim 6, wherein the step of macerating the tea mixture is performed for about 2 hours.

13. The method for manufacturing a liquid tea concentrate of claim 6, wherein the step of boiling the tea bulk is performed for 30 minutes.

14. The method for manufacturing a liquid tea concentrate of claim 6, wherein the step of removing the coarse particles is performed by a centrifugal separator.

15. The method for manufacturing a liquid tea concentrate of claim 6, further comprising the step of collecting the liquid tea concentrate in a closed chamber.

16. The method for manufacturing a liquid tea concentrate of claim 15, further comprising the step of filling containers from the closed chamber.

17. The method for manufacturing a liquid tea concentrate of claim 16, further comprising the step of sterilizing at least one of the closed tank and the closed chamber.

18. The method for manufacturing a liquid tea concentrate of claim 15, further comprising the step of using the liquid tea concentrate as an ingredient in a commercial food product.

19. A method for manufacturing a liquid tea concentrate, the method comprising:
combining tea, glycerin and water to form a tea mixture, wherein the tea comprises at least one of black tea, green tea, white tea, or oolong tea, wherein the tea is 40% dry solid, wherein the glycerin comprises one of glycerol, 1,2,3 propanetriol and glycyl alcohol, wherein the glycerin is 65% of the net liquid weight of the tea mixture, wherein the water is 35% of the net liquid weight of the tea mixture
macerating the tea mixture in a closed sterilized tank for 2 hours to form a tea bulk;
boiling the tea bulk for 30 minutes to form a boiled tea bulk;
removing coarse particles from the boiled tea bulk with a centrifugal separator to form a clarified liquid;
spray drying the clarified liquid to form a liquid tea concentrate;
collecting the liquid tea concentrate in a closed sterilized chamber; and
filling containers from the closed sterilized chamber.

20. The method for manufacturing a liquid tea concentrate of claim 19, further comprising the step of adding spices to the tea mixture.
